(19) United States
(12) Patent Application Publication
(10) Pub. No.: US 2018/0352725 A1
(43) Pub. Date: Dec. 13, 2018

(54) MECHANIZED DEVICE FOR PLANTING VEGETABLES

(71) Applicant: INSTITUT NATIONAL DE RECHERCHE EN SCIENCES ET TECHNOLOGIES POUR L'ENVIRONEMENT ET L'AGRICULTURE, ANTONY (FR)

(72) Inventors: MICHAEL DOUCET, CALIGNAC (FR); ANICET MARIONNEAU, CHARMEIL (FR); ISTIVEN APAVOO, CLERMONT-FERRAND (FR)

(21) Appl. No.: 15/777,206

(22) PCT Filed: Nov. 18, 2016
(86) PCT No.: PCT/FR2016/053015

§ 371 Date: May 17, 2018

(30) Foreign Application Priority Data
Nov. 18, 2015 (FR) 1561105

(51) Int. Cl. A01C 11/00

(52) U.S. Cl. CPC A01C 11/006

(57) ABSTRACT

A mechanized device to plant vegetables. The device includes a first actuator to enable horizontal movement of a planting module and a second actuator to enable vertical movement of the planting module. The horizontal movement and the vertical movement of the planting module are carried out in a synchronized manner.

### TECHNICAL FIELD

The present invention relates to the field of farming and forest equipment.

The present invention more specifically relates to a mechanized device for planting vegetables.

### STATE OF THE ART

Currently, for example in the forest sector, a large proportion of planting is carried out manually. Only around twenty percent of planting is mechanized. But current mechanized planting systems are not suitable for forest terrain, which in particular comprises stumps and roots. Indeed, a trend of clogging in a forest environment with current devices has been observed.

In the state of the art, the device called “PLANTACÔNE” (trademark) is known, which has technical benefits but which is not suitable for planting in a forest environment.

In the state of the art, a system by the brand BRACKE (trademark) is also known, produced in Scandinavia and mounted on a digger. This system enables to plant one hundred and fifty plants per hour, which is relatively little.

### DESCRIPTION OF THE INVENTION

The present invention intends to remedy the disadvantages of the prior art by proposing a device enabling to function in forest and farming environments and offering a rate for planting a plant every two seconds per planting module.

To this end, the present invention relates to, in the most general acceptance, a mechanized device for planting vegetables, comprising:
actuation means enabling a horizontal movement of a planting module;
actuation means enabling a vertical movement of a planting module;
   said horizontal movement and said vertical movement of said planting module being carried out in a synchronised manner.

Thus, the device according to the present invention enables to modulate in a configurable manner, the distance between the plants. Thanks to the present invention, planting is continuous, whatever the forward speed of the motor vehicle on which the mechanized device is installed.

The device according to the present invention in particular enables to work in a forest environment, which comprises stumps, roots, tree branches, stones/rocks and numerous other debris of natural origin, and to have a rate of planting a plant every two seconds per planting module.

The device according to the present invention also enables to have a great precision in the interval between each plant and in the position (X, Y) of each plant.

In addition, the device according to the present invention is very robust, in particular because there is no slipping or sliding in carrying out the movements.

Advantageously, said horizontal movement and said vertical movement are exerted along a double parallelogram, the two parallelograms being deformable.

This enables to plant vertically.

Preferably, the movement of the vertical parallelogram is controlled by an actuator towards the front and is free towards the rear.

According to an embodiment, said device comprises safety mechanisms along the axes X, Y and Z, according to which, along the axis X, a safety device is triggered above a certain pressure threshold, and, along the axis Z, the nozzle rises if an obstacle is encountered.

Preferably, said device comprises processing means and at least one sensor.

Advantageously, said device further comprises a subassembly formed of a nozzle-supporting chassis connected to the feet.

According to an embodiment, said feet exert a pressure on the ground using a mechanical packing actuator.

According to an embodiment, said feet are independent of each other and each have a mechanical actuator as well as a sensor comprising means for detecting the ground level in relation to the nozzle, even on slopes or cants.

According to a variant, the mechanical actuators connected to the feet comprise means for enabling the feet to exert a controlled pressure to pack the ground at the time when the nozzle exits the ground.

According to a variant, said device is connected to a tractor vehicle and it comprises means for controlling the distance of the plants, whatever the speed of said tractor.

Advantageously, said device is capable of being connected to a telescopic beam enabling to assemble at least one or more mechanized devices for planting vegetables.

According to an embodiment, said subassembly further comprises a member for packing and consolidating the ground around the plant once the latter has been planted.

According to an embodiment, said subassembly further comprises a member for opening and closing the nozzle.

With the aim of placing plants vertically, whatever the slopes and cants within a limit of 25%, the device comprises mechanical actuators for adjusting slopes and cants.

According to a variant, said device further comprises a mechanical device for adjusting slopes.

Advantageously, said device further comprises a mechanical actuator for adjusting cants.

According to an embodiment, said mechanical actuator for adjusting cants actuates the rotation of all of said device around an axis parallel to the forward direction.

According to another embodiment, said mechanical actuator for adjusting cants actuates the rotation of the nozzle-supporting chassis in relation to an axis parallel to the forward direction.

According to an embodiment, said device comprises means for programming the planting depth.

According to a variant, said device further comprises geolocation means enabling to finely control the planting precision by triggering, in a spatialised manner (over one same row or between consecutive rows), the action of the planting module(s).

Preferably, said device further comprises a module for storing and supplying plants.

In an embodiment, said storage module comprises a mobile submodule with a capacity greater than one thousand plants which enables to bring the plants to an operator responsible for supplying said device by the intermediary of a cylinder.

In another embodiment, said storage module comprises a mobile submodule with a capacity greater than one thousand plants which enables to bring the plants to an automatic supplying device equipped with clamps or any other type of gripper which deposits plants in a cylinder.

Advantageously, said storage module also comprises a fixed storage submodule with a capacity at least equal to the mobile submodule, of which the objective is to resupply the mobile device when it is empty.

The present invention also relates to a method for planting vegetables, comprising the following steps:
a step of actuating by means of actuators, enabling a horizontal movement of a planting module;
a step of actuating by means of actuators, enabling a vertical movement of a planting module;
   said horizontal movement and said vertical movement of said planting module being carried out in a synchronised manner.

### BRIEF DESCRIPTION OF THE DRAWINGS

The invention will be best understood thanks to the description, made below, purely for information purpose, of an embodiment of the invention, in reference to the Figures wherein:

FIGS. 1 to 5 illustrate the device according to the present invention in an embodiment according to different views.

### DETAILED DESCRIPTION OF EMBODIMENTS OF THE INVENTION

The present invention relates to a mechanized device 10 for planting vegetables, comprising:
actuation means enabling a horizontal movement of a planting module;
actuation means enabling a vertical movement of a planting module;

said horizontal movement and said vertical movement of said planting module being carried out in a synchronised manner.

It is possible to consider two parallelograms: one parallelogram enabling horizontal movement and one parallelogram enabling vertical movement.

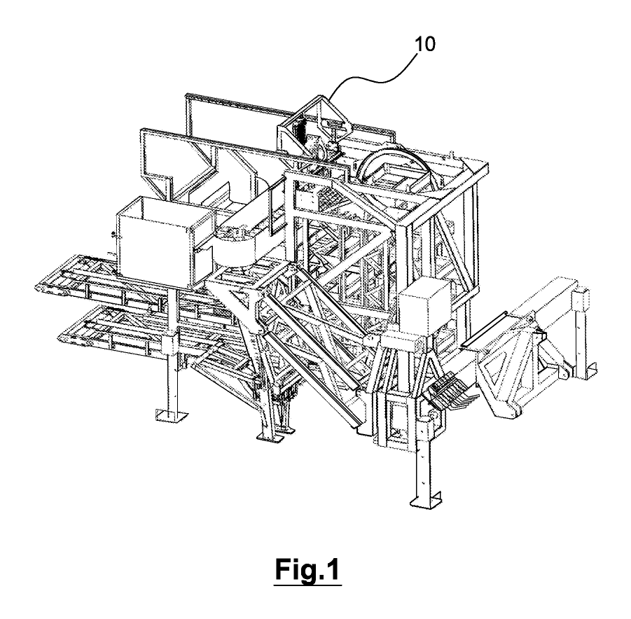

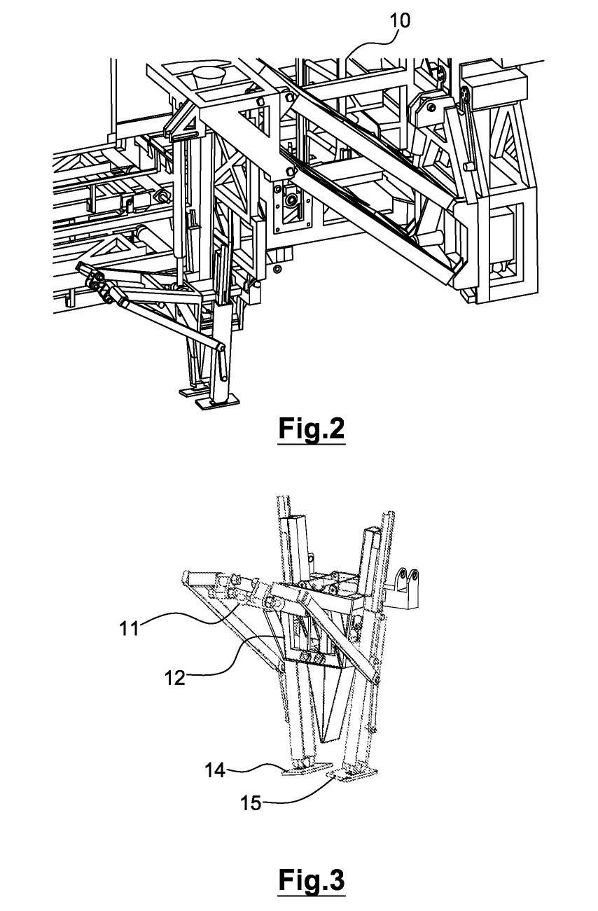

This mechanized device 10 for planting vegetables is illustrated in FIGS. 1 to 5.

The device 10 according to the present invention can be used with a farming-type tractor. It can be equipped with one or more planting modules. Therefore, road width is respected and no support vehicle is necessary.

In an embodiment, the device 10 comprises processing means and at least one sensor. These means enable this, such that said horizontal movement and said vertical movement of said planting module are carried out in a synchronised manner.

In an embodiment, said device 10 further comprises a subassembly formed of a nozzle-supporting chassis connected to the feet 14, 15.

The nozzle is substantially sunken vertically into the ground.

In an embodiment, said device 10 further comprises a mechanical packing actuator 11.

The feet 14 and 15 exert a pressure on the ground thanks to said mechanical packing actuator 11. The feet 14 and 15 are independent of each other and each have a mechanical actuator as well as a sensor enabling to detect the ground level in relation to the nozzle, even on slopes or cants and these same mechanical actuators also enable the feet to exert a controlled pressure to pack the ground at the time when the nozzle exits the ground.

In an embodiment, said device 10 further comprises a mechanical actuator 12 for opening the nozzle.

In FIG. 3, the mechanical packing actuator 11, the mechanical actuator 12 for opening the nozzle and the feet 14, 15 are observed.

With the objective of placing plants vertically, whatever the slopes and cants, within a limit of 25%, the device comprises mechanical actuators for adjusting slopes and cants.

Adjusting slopes is carried out by a mechanical actuator, actuating the rotation of the nozzle-supporting chassis around an axis perpendicular to the forward direction.

Adjusting cants is carried out, in a first embodiment, by a mechanical actuator 13 actuating the rotation of the whole machine around an axis parallel to the forward direction and in a second embodiment by a mechanical actuator 13 actuating the rotation of the nozzle-supporting chassis in relation to an axis parallel to the forward direction.

These mechanical actuators can, for example, be actuators.

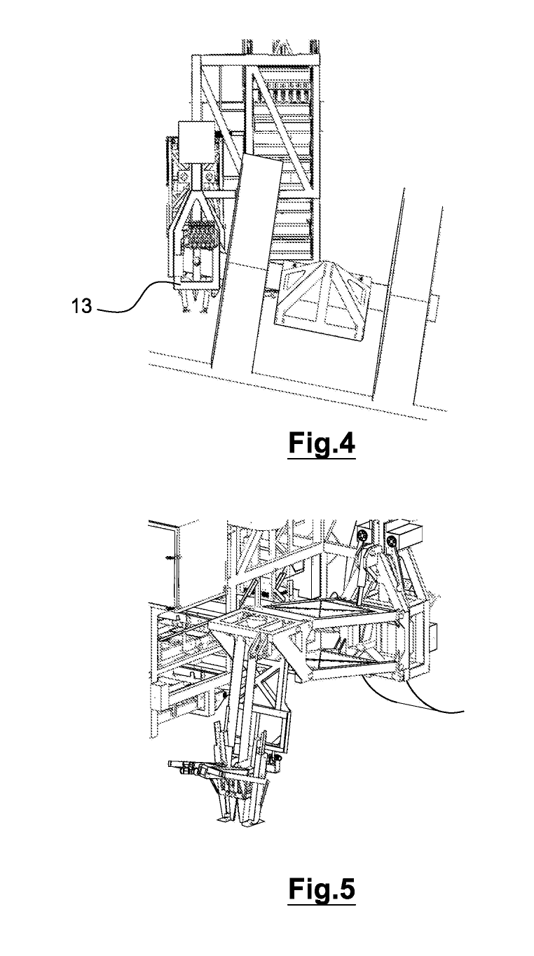

In FIG. 4, the mechanical actuator 13 for adjusting cants can be seen.

The device 10 according to the present invention enables to work with slopes and cants of 25%. Thanks to the mechanical actuators for adjusting slopes and for adjusting cants, the device 10 according to the present invention remains stable and the nozzle-supporting chassis remains substantially horizontal.

In an embodiment, said device 10 comprises means for programming the planting depth. This planting depth can reach up to 30 cm.

In an embodiment, said device 10 further comprises geolocation means, enabling to finely control the planting precision, by triggering in a spatialised manner (over one same row and between consecutive rows), the action of the planting module(s).

It is noted, that other means enable to measure the movement, for example, non-exclusively: a Doppler effect speed radar, a laser sensor, an inertial unit, a wheel capable of measuring movement, etc.

The device 10 according to the present invention is also connected, in certain embodiments, to a man-machine interface.

The device 10 according to the present invention also comprises safety mechanisms along the axes X, Y and Z. For example, along the axis X, the safety device is triggered above a certain pressure threshold. Along the axis Z, the nozzle can rise if an obstacle is encountered.

Forces can be limited upon encountering obstacles on the descending mechanical actuator. Likewise, lateral forces on the nozzle can be limited by adapted safety devices (passive or active).

There are also means for configuring the device.

Thanks to the sensors and to the processing means present in the device 10 according to the present invention, an adjustment of the device is carried out.

The device 10 according to the present invention also comprises, in the embodiments, modules for storing and supplying plants.

The storage module comprises a mobile device with a capacity greater than one thousand plants, which enables to bring plants, either up to the operator responsible for supplying the planter by the intermediary of a cylinder, or up to an automatic supplying device equipped with clamps or any other type of gripper which deposits plants in a cylinder.

This storage device also comprises a fixed storage device with a capacity equal to the mobile device, of which the objective is to resupply the mobile device when it is empty.

The storage unit thus enables to work for several hours without requiring to exit the planting zone to be resupplied with plants.

The present invention also relates to a method for planting vegetables, comprising the following steps:
a step of actuating by means of actuators, enabling a horizontal movement of a planting module;
a step of actuating by means of actuators, enabling a vertical movement of a planting module;
   said horizontal movement and said vertical movement of said planting module being carried out in a synchronised manner.

In addition, in an embodiment, a telescopic beam enables to assemble one or more planting modules connected to a tractor vehicle. For example, in forest planting, these planting modules enable two rows situated between 3 m and 4.5 m from each other to be planted at the same time, by enabling a continuous adjustment, enabling to follow a straight-lined path from the information coming from a sensor, for example of GPS, laser, gyroscope, etc. type.

The pivoting wheels placed at the ends of the beam have the function of stabilising the planters on a rough surface and reconsolidating the ground before planting.

The telescopic beam is composed of three beams which are embedded in each other, which are adjustable by actuators equipped with linear sensors. This beam thus enables to reduce the volume by width of the two planters at least by 3.5 m, in order to adhere to the Highway Code for a farming vehicle travelling on the road without a support vehicle.

The invention is defined above as an example. It is understood that a person skilled in the art is able to produce different variants of the invention, without moving away from the scope of the patent.

1-24. (canceled)

25. A mechanized device to plant vegetables, comprising:
a first actuator to enable a horizontal movement of a planting module;
a second actuator to enable a vertical movement of the planting module; and
wherein said horizontal movement and said vertical movement of said planting module are carried out in a synchronised manner.

26. The mechanized device according to claim 25, wherein said horizontal movement and said vertical movement are exerted along a double parallelogram, vertical and horizontal parallelograms being deformable.

27. The mechanized device according to claim 26, wherein a movement of the vertical parallelogram is controlled by the second actuator towards front of the vertical parallelogram and is free towards rear of the vertical parallelogram.

28. The mechanized device according to claim 25, further comprising safety mechanisms along X, Y and Z axes, wherein along the axis X, a safety element is triggered in response to a determination that a pressure is above a predetermined threshold, and wherein along the Z axis, a nozzle rises in response to an encounter of an obstacle.

29. The mechanized device according to claim 25, further comprising a processor and at least one sensor.

30. The mechanized device according to claim 25, further comprising a subassembly formed of a nozzle-supporting chassis connected to feet of the mechanized device.

31. The mechanized device according to claim 30, further comprising a mechanical packing actuator configured to enable said feet exert a pressure on the ground.

32. The mechanized device according to claim 30, wherein said feet are independent of each other and each foot has a mechanical actuator and a sensor configured to detect a ground level in relation to a nozzle of the mechanized device.

33. The mechanized device according to claim 32, wherein the mechanical actuators connected to said feet are configured to enable said feet to exert a controlled pressure to pack the ground on exit of the nozzle from the ground

34. The mechanized device according to claim 25 is connected to a tractor or other type of farming or forest vehicle, including a robotic vehicle, collectively referred to as a tractor vehicle; and further comprising a controller to control, in a configurable manner, a distance between planted vegetables regardless of a speed of said tractor vehicle.

35. The mechanized device according to claim 25 is configured to be connected to a telescopic beam to enable assembly of one or more mechanised devices.

36. The mechanized device according to claim 30, wherein said subassembly further comprises a packer to pack and consolidate the ground around a planted vegetable.

37. The mechanized device according to claim 30, wherein said subassembly further comprises a mechanical actuator to open and close a nozzle of the mechanized device.

38. The mechanized device according to claim 25, further comprising a mechanical actuator to adjust slopes.

39. The mechanised device according to claim 25, further comprising a mechanical actuator to adjust cants.

40. The mechanized device according to claim 39, wherein said mechanical actuator is configured to actuate a rotation of all of said device around an axis parallel to a forward direction.

41. The mechanized device according to claim 39, wherein said mechanical actuator is configured to actuate a rotation of a nozzle-supporting chassis in relation to an axis parallel to a forward direction.

42. The mechanized device according to claim 25, further comprising a processor configured to program a planting depth for planting the vegetables.

43. The mechanized device according to claim 25, further comprising a geo-locater to control planting precision of the vegetables by triggering, in a spatialised manner over one same row or between consecutive rows, an action of said planting module.

44. The mechanized device according to claim 25, further comprising a storage to store and supply the vegetables for planting.

45. The mechanized device according to claim 44, wherein said storage comprises a mobile storage with a capacity greater than one thousand vegetables for planting to supply the mechanized device by an intermediary of a cylinder.

46. The mechanised device according to claim 44, wherein said storage comprises a mobile storage with a capacity greater than one thousand vegetables for planting to supply an automatic supplying device equipped with clamps or other type of gripper to deposit the vegetables for planting in a cylinder.

47. The mechanized device according to claim 46, wherein said storage comprises a fixed storage, with a capacity at least equal to the mobile storage, configured to resupply the mobile storage when the mobile storage is empty.

48. A method for planting vegetables, comprising steps of:
actuating by first actuators to enable a horizontal movement of a planting module;
actuating by second actuators to enable a vertical movement of the planting module; and
wherein said horizontal movement and said vertical movement of the planting module are carried out in a synchronised manner.
